(19) United States
(12) Patent Application Publication
(10) Pub. No.: US 2011/0142473 A1
(43) Pub. Date: Jun. 16, 2011

(54) FIXING DEVICE

(75) Inventor: Masaya Tanaka, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/967,257

(22) Filed: Dec. 14, 2010

Related U.S. Application Data
(60) Provisional application No. 61/287,010, filed on Dec. 16, 2009.

(51) Int. Cl. G03G 15/20

(52) U.S. Cl. 399/69

(57) ABSTRACT

According to one embodiment, a fixing device includes: a heating member configured to heat a toner image formed on a recording medium; a pressing member configured to come into press contact with the heating member and nip and convey a sheet in cooperation with the heating member; a first heat generation source configured to heat the heating member; a second heat generation source configured to heat the pressing member; a measured-temperature-information acquiring unit configured to acquire measured temperature information concerning measured temperatures of the heating member and the pressing member; a target specifying unit configured to specify, using the measured temperature information acquired by the measured-temperature-information acquiring unit, the heating member or the pressing member as a member, the measured temperature of which is equal to or lower than predetermined temperature and a temperature difference between the measured temperature and the predetermined temperature of which is larger; and a heating control unit configured to control the first heat generation source and the second heat generation source and set the rate of increase in the heat quantity to be given to the heating member or the pressing member specified by the target specifying unit larger.

### CROSS-REFERENCE TO RELATED APPLICATION

This application is also based upon and claims the benefit of priority from U.S. provisional application 61/287,010, filed on Dec. 16, 2009, the entire contents of which are incorporated herein by reference.

### FIELD

Embodiments described herein relate generally to a technique concerning a fixing device.

### BACKGROUND

In a fixing device, printing can be prepared when both the temperature of a heating member such as a heating roller and the temperature of a pressing member such as a pressing roller reach predetermined target temperatures (a ready state). Therefore, when one of the temperatures reaches the target temperature earlier, there is a waiting time until the other reaches the target temperature.

### DESCRIPTION OF THE DRAWINGS

FIG. 1 is a longitudinal sectional view of a schematic configuration of an image forming apparatus mounted with a fixing device according to a first embodiment;

FIG. 2 is a longitudinal sectional view of a schematic configuration of the fixing device according to the first embodiment;

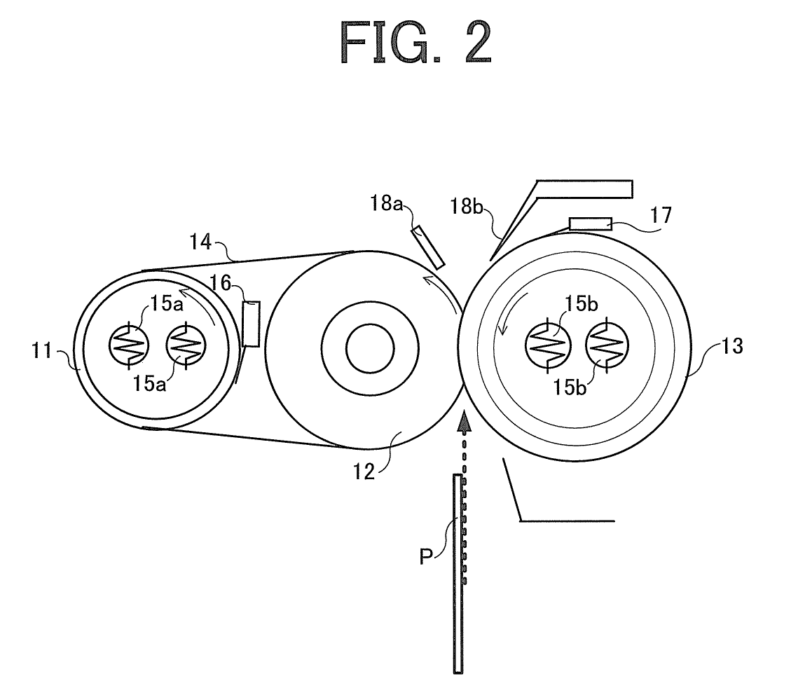

FIG. 3 is a functional block diagram in the fixing device according to the first embodiment;

FIG. 4 is a diagram of an example of a target temperature table according to the first embodiment;

FIG. 5 is a diagram of an example of a heating control table according to the first embodiment;

FIG. 6 is a flowchart for explaining a processing flow of heating control according to the first embodiment;

FIG. 7 is a flowchart for explaining a processing flow of the heating control according to the first embodiment;

FIG. 8 is a diagram for explaining a relation between elapse of time after the acquisition of a start request and temperature and electric energy in the past;

FIG. 9 is a diagram for explaining a relation between elapse of time after the acquisition of a start request and temperature and electric energy in the first embodiment;

FIG. 10 is a functional block diagram in a fixing device according to a second embodiment;

FIG. 11 is a diagram of an example of a heating control table according to the second embodiment;

FIG. 12 is a flowchart for explaining a processing flow of heating control according to the second embodiment;

FIG. 13 is a diagram for explaining a relation between elapse of time after the acquisition of a start request and temperature and rotating speed (pre-run speed) of a roller in the past;

FIG. 14 is a diagram for explaining a relation between elapse of time after the acquisition of a start request and temperature and rotating speed (pre-run speed) of a roller in the second embodiment;

FIG. 15 is a schematic diagram of the configuration of a fixing device according to a third embodiment;

FIG. 16 is a schematic diagram of the configuration of the fixing device according to the third embodiment;

FIG. 17 is a functional block diagram in the fixing device according to the third embodiment;

FIG. 18 is a diagram of an example of a heating control table according to the third embodiment;

FIG. 19 is a flowchart for explaining a processing flow of heating control according to a fourth embodiment;

FIG. 20 is a functional block diagram in a fixing device according to the fourth embodiment;

FIG. 21 is a diagram of an example of a heating control table according to the fourth embodiment;

FIG. 22 is a flowchart for explaining a processing flow of heating control according to the fourth embodiment;

FIG. 23 is a functional block diagram in a fixing device according to another embodiment; and

FIG. 24 is a longitudinal sectional view of a schematic configuration of the fixing device according to still another embodiment.

### DETAILED DESCRIPTION

### First Embodiment

A fixing device according to a first embodiment includes a heating member, a pressing member, a first heat generation source, a second heat generation source, a measured-temperature-information acquiring unit, a target specifying unit, and a heating control unit.

The heating member is heated by the first heat generation source and heats a toner image formed on a recording medium. The pressing member is heated by the second heat generation source, comes into press contact with the heating member, and nips and conveys a sheet in cooperation with the heating member. The measured-temperature-information acquiring unit acquires measured temperature information concerning measured temperatures of the heating member and the pressing member. The target specifying unit specifies, using the measured temperature information acquired by the measured-temperature-information acquiring unit, the heating member or the pressing member as a member for which a rate of increase in a heat quantity to be given is set larger. The heating control unit controls the first heat generation source and the second heat generation source and sets the rate of increase in the heat quantity to be given to the heating member or the pressing member specified by the target specifying unit larger.

The first embodiment is explained below with reference to the accompanying drawings.

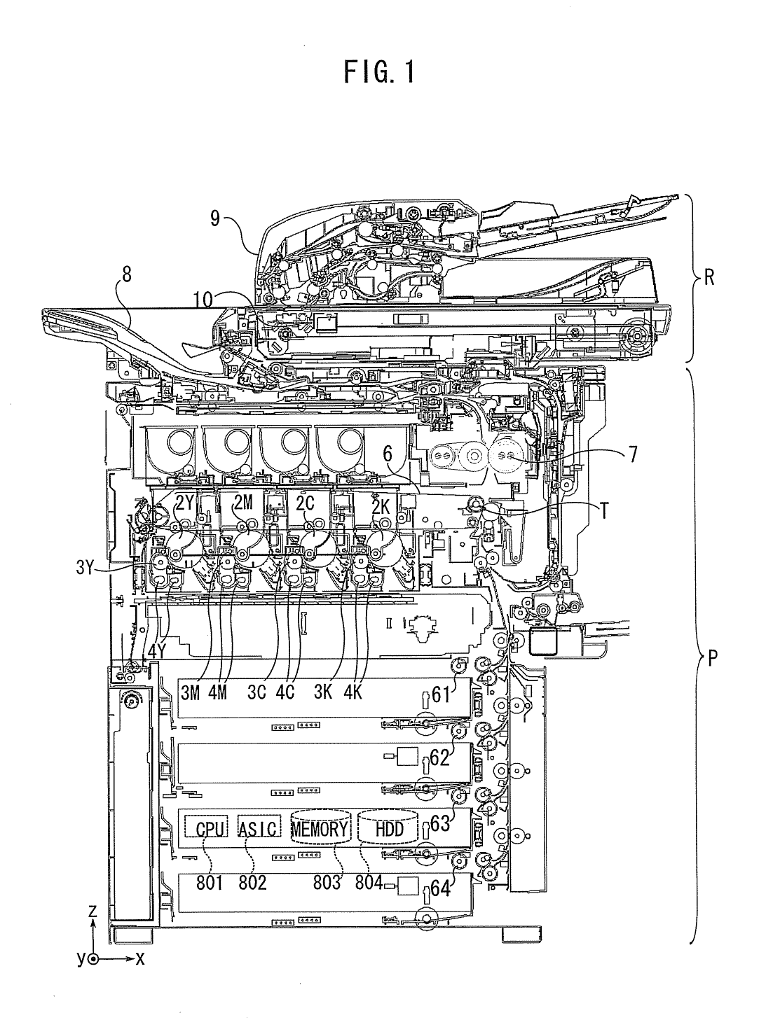

FIG. 1 is a longitudinal sectional view of a schematic configuration of an image forming apparatus (MFP: Multi Function Peripheral) mounted with the fixing device according to the first embodiment.

As shown in FIG. 1, the MFP includes an image reading section R and an image forming section P.

The image reading section R has a function of scanning to read images of a sheet document and a book document.

The image forming section P has a function of forming a developer image on a sheet on the basis of, for example, an image read from an original document by the image reading section R or image data transmitted from an external apparatus to the image forming apparatus.

The image reading section R includes an auto document feeder (ADF) 9 that can automatically convey an original document to a predetermined image reading position. The image reading section R reads, with a scanning optical system 10, an image of an original document automatically conveyed by the auto document feeder 9 or an image of an original document placed on a document table.

The image forming section P includes pickup rollers 61 to 64, photoconductive members 2Y to 2K, developing rollers 3Y to 3K, mixers 4Y to 4K, an intermediate transfer belt 6, a fixing device 7, and a discharge tray 8.

The MFP according to the first embodiment includes a CPU 801, an ASIC (Application Specific Integrated Circuit) 802, a memory 803, and a HDD (Hard Disk Drive) 804. The CPU 801 has a role of performing various kinds of processing in the MFP and also has a role of realizing various functions by executing computer programs temporarily stored in the memory 803. It goes without saying that the CPU 801 can be replaced with an MPU (Micro Processing Unit) that can execute arithmetic processing equivalent to arithmetic processing executed by the CPU 801. Similarly, the HDD 804 can be replaced with a storage device such as a flash memory.

The ASIC 802 is mounted with hardware (a circuit) configured to control various functions of the MFP.

The memory 803 can include, for example, a RAM (Random Access memory), a ROM (Read Only Memory), a DRAM (Dynamic Random Access Memory), an SRAM (Static Random Access Memory), or a VRAM (Video RAM). The memory 803 has a role of temporarily storing, for example, various kinds of information and computer programs used in the MFP and log information of executed processing. For example, a computer program and data stored in the HDD 804 are read out to the memory 803 by the CPU 801. The CPU 801 executes processing using the computer program and the data read out to the memory 803. The CPU 801 causes the memory 803 to store information generated in a process of the processing, for example, log information of the processing and information concerning the number of sheets explained later.

As an example of the fixing device according to the first embodiment, an overview of copy processing performed when the fixing device is mounted on the MFP is explained below.

First, sheets picked up from cassettes by the pickup rollers 61 to 64 are fed into a sheet conveying path. The sheets fed into the sheet conveying path are conveyed in a predetermined conveying direction by plural roller pairs.

Images of plural sheet original documents continuously automatically conveyed by the auto document feeder 9 are read by the scanning optical system 10 in a predetermined image reading position.

Electrostatic latent images are formed on photoconductive surfaces of the photoconductive members 2Y, 2M, 2C, and 2K on the basis of image data of the images read from the original documents in the image reading section R. The photoconductive members 2Y, 2M, 2C, and 2K are members for transferring developer images of yellow (Y), magenta (M), cyan (C), and black (K) onto the sheets.

Subsequently, developers agitated by the mixers 4Y to 4K (equivalent to agitating units) in a developing device are supplied to the photoconductive members 2Y to 2K, on which the electrostatic latent images are formed as explained above, by the developing rollers (so-called mag rollers) 3Y to 3K. Consequently, the electrostatic latent images formed on the photoconductive surfaces of the photoconductive members 2Y to 2K are visualized.

The developer images formed on the photoconductive members 2Y to 2K in this way are transferred onto the belt surface of the intermediate transfer belt 6 (so-called primary transfer). The developer images conveyed by the rotation of the intermediate transfer belt 6 are transferred onto the conveyed sheets in a predetermined secondary transfer position T.

The developer images transferred onto the sheets are heated and fixed on the sheet in the fixing device 7.

The sheets having the developer images heated and fixed thereon are conveyed through a conveying path by plural conveying roller pairs and sequentially discharged onto the discharge tray 8.

Details of the fixing device 7 according to the first embodiment are explained below.

The fixing device 7 includes a heating roller 11, a fixing roller 12 (equivalent to a stretching and suspending roller), a pressing roller 13, a fixing belt 14, halogen heaters 15a and 15b, and non-contact temperature sensors 16 and 17.

The fixing belt 14 is laid over the heating roller 11 and the fixing roller 12 and wound and suspended around the heating roller 11 and the fixing roller 12 with predetermined tension by a tension mechanism. The heating roller 11 is driven in an arrow direction by a driving motor (not shown). The fixing roller 12 and the fixing belt 14 are configured to rotate in an arrow direction following the rotation of the heating roller 11. The pressing roller 13 (equivalent to the pressing member) is in press contact with the fixing roller 12 across the fixing belt 14 by a pressing mechanism and maintained to have fixed nip width. Therefore, the pressing roller 13 also rotates in an arrow direction following the rotation of the heating roller 11. In the first embodiment, the heating roller 11 and the fixing belt 14 are equivalent to the heating member.

The heating roller 11 is desirably obtained by coating a hollow cored bar of aluminum or iron with a coating layer of PTFE in order to prevent abrasion. A thin roller is desirably used to reduce heat capacity in order to improve temperature rise of the device.

In the first embodiment, plural (e.g., two) halogen heaters 15a (equivalent to the first heat generation source) are arranged on the inside of the heating roller 11 as a heat generation source.

As the fixing belt 14, an endless belt containing electroformed nickel, stainless steel, or polyimide as a base material and having a heat-resistant elastic layer of silicon rubber on the outer circumferential surface thereof is used. A belt covered or coated with high-releasability fluorine resin such as a PFA tube on the outer side thereof to improve releasability is also used.

The fixing roller 12 is a roller obtained by providing a heat-resistant elastic layer formed of silicon sponge or the like on a cored bar. A roller having low hardness is desirable from the viewpoint of securing a wide nip.

The pressing roller 13 is obtained by covering a hollow cored bar of aluminum or iron with silicon rubber. It is desirable to cover the outer side of the pressing roller 13 with the PFA tube for the purpose of improving releasability. One or plural (e.g., two) halogen heaters 15b (equivalent to the second heat generation source) are disposed on the inner side of the pressing roller 13 as a heat generation source.

A sheet P passes a fixing point that is a press contact section (a nip section) of the fixing roller 12, the fixing belt 14, and the pressing roller 13, whereby a developer on the sheet is fused, compression-bonded, and fixed.

In the first embodiment, the temperature sensor 16 configured to detect the temperature of the heating roller 11 is provided near the surface of the heating roller 11. The temperature sensor 17 configured to detect the surface temperature of the pressing roller 13 is provided in a position near the surface of the pressing roller 13.

On the circumference of the fixing belt 14, a peeling blade 18a configured to peel off the sheet P from the belt surface of the fixing belt 14 is provided further on a downstream side in a rotating direction of the fixing belt 14 than a contact position (the nip section) of the fixing belt 14 and the pressing roller 13. Similarly, a peeling blade 18b configured to peel off the sheet P from the pressing roller 13 is provided further on the downstream side in the rotating direction than the nip section.

Functional blocks concerning heating control in the fixing device according to the first embodiment are explained below.

In the first embodiment, it is assumed that, when the fixing device acquires a start request, the fixing device turns on, on the basis of the control by the CPU 801, the two halogen heaters 15a and the two halogen heaters 15b and starts heating of the heating roller 11 and the pressing roller 13 using a computer program and setting information read out to the memory 803.

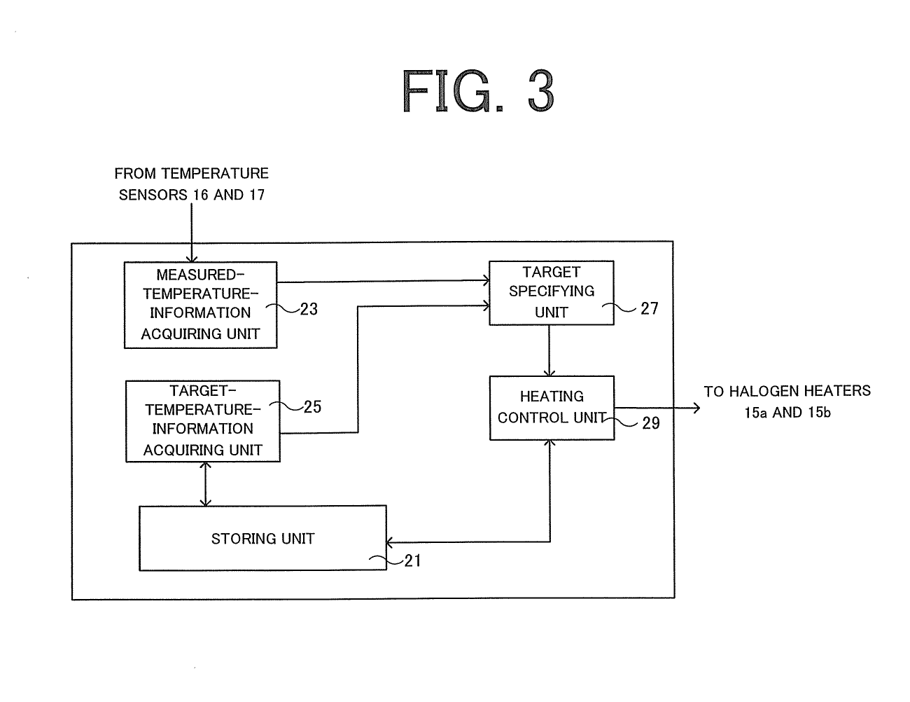

As shown in FIG. 3, the fixing device according to the first embodiment includes a storing unit 21, a measured-temperature-information acquiring unit 23, a target-temperature-information acquiring unit 25, a target specifying unit 27, and a heating control unit 29. For example, the functional blocks can be realized by the CPU 801 executing computer programs read out to the memory 803.

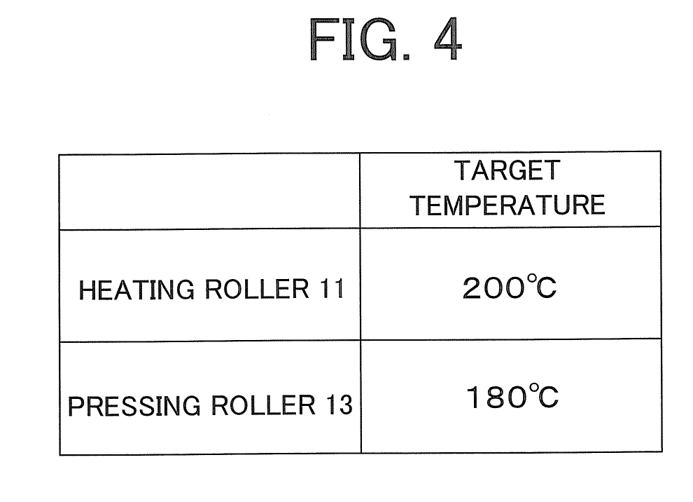

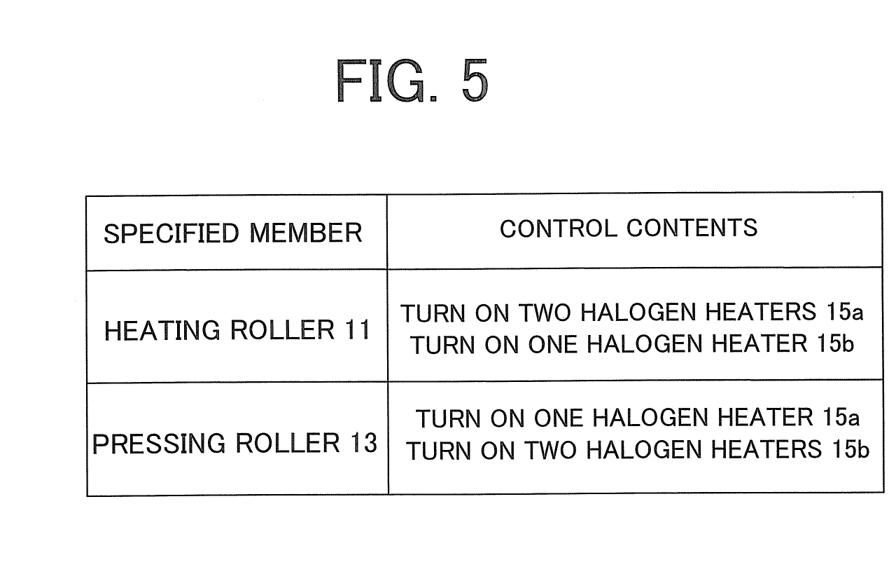

The storing unit 21 stores a target temperature table shown in FIG. 4 that associates the heating roller 11 and the pressing roller 13 and target temperatures thereof and a heating control table shown in FIG. 5 that associates results of specifying by the target specifying unit 27 (explained in detail later) and heating control on the heating roller 11 and the pressing roller 13.

The measured-temperature-information acquiring unit 23 acquires the temperatures of the heating roller 11 and the pressing roller 13 from the non-contact temperature sensors 16 and 17 as measured temperature information and sends the temperatures to the target specifying unit 27 and the heating control unit 29. For example, when start processing by the CPU 801 proceeds and the measured-temperature-information acquiring unit 23 becomes capable of acquiring measured temperature information, the measured-temperature-information acquiring unit 23 executes acquisition of measured temperature information.

The target-temperature-information acquiring unit 25 acquires the target temperature table shown in FIG. 4 from the storing unit 21 as target temperature information and sends the target temperature table to the target specifying unit 27 and the heating control unit 29.

In the first embodiment, timing for the measured-temperature-information acquiring unit 23 to acquire the measured temperature information and timing for the target-temperature-information acquiring unit 25 to acquire the target temperature table can be set by a computer program in advance. The timings can be set taking into account time until start processing for the functional blocks is completed. For example, the timings can be set taking into account time from acquisition of a start request until the start processing by the CPU 801 proceeds and the measured-temperature-information acquiring unit 23 and the target-temperature-information acquiring unit 25 become capable of respectively acquiring the measured temperature information and the target temperature information. The timings can also be set taking into account, for example, time from the acquisition of the start request until the control of the halogen heaters 15a and 15b by the heating control unit 29 becomes possible. Specifically, for example, the timings can be set to 20 seconds after the fixing device 7 acquires the start request.

The target specifying unit 27 specifies, using the measured temperature information sent from the measured-temperature-information acquiring unit 23 and the target temperature table sent from the target-temperature-information acquiring unit 25, the heating roller 11 or the pressing roller 13 as a target for which a rate of increase in a heat quantity to be given is set larger.

Specifically, first, the target specifying unit 27 determines which of a temperature difference between the target temperature and the measured temperature in the heating roller 11 and a temperature difference between the target temperature and the measured temperature in the pressing roller 13 is larger. The target specifying unit 27 executes processing of the determination using the measured temperature information sent from the measured-temperature-information acquiring unit 23 and the target temperature table sent from the target-temperature-information acquiring unit 25.

Subsequently, the target specifying unit 27 determines, using the measured temperature information and the target temperature table, whether the temperature of the heating roller 11 or the pressing roller 13, the temperature difference between the target temperature and the measured temperature of which is determined as larger, is equal to or higher than the target temperature. The target specifying unit 27 specifies the roller, the temperature of which is determined as lower than the target temperature in the determination, as a target for which a rate of increase in a heat quantity to be given is set larger than that for the other roller. The target specifying unit 27 generates information indicating the specified target (hereinafter referred to as target specifying information) and sends the information to the heating control unit 29.

In other words, the target specifying unit 27 specifies, as a member for which a rate of increase in a heat quantity to be given is set larger, a member, measured temperature of which is equal to or lower than predetermined temperatures (the target temperatures) respectively set for the heating roller 11 and the pressing roller 13 and a temperature difference between the measured temperature and the predetermined temperature of which is determined as larger.

In this specification, the rate of increase is a concept including a value 0 or a negative value. Specifically, when the rate of increase is 0, this means that, even after execution of processing by the heating control unit 29 explained later, a heat quantity per unit time same as that before the execution is given to the rollers. When the rate of increase indicates a negative value, this means that a heat quantity given per unit time after the execution of the processing by the heating control unit 29 is smaller than that before the execution. For example, when the number of halogen heaters to be turned on is changed from two to one, the rate of increase indicates a negative value.

The heating control unit 29 controls the halogen heaters 15a and 15b on the basis of the target specifying information sent from the target specifying unit 27. According to the control, the heating control unit 29 increases a heat quantity of heat given to the heating roller 11 or the pressing roller 13 specified by the target specifying unit 27 to set a rate of increase in the heat quantity given to the specified roller larger. Specifically, the heating control unit 29 sets a rate of increase in electric energy to be given larger for the halogen heaters 15a or the halogen heaters 15b corresponding to the specified roller than for the other heater. More specifically, the heating control unit 29 acquires, according to the acquisition of the target specifying information sent from the target specifying unit 27, the heating control table stored in the storing unit 21. Subsequently, the heating control unit 29 changes, on the basis of the heating control table, the number of the halogen heaters to be turned on.

For example, it is assumed that the heating roller 11 is specified by the target specifying unit 27. In this case, the heating control unit 29 changes, on the basis of the heating control table shown in FIG. 5, the number of the halogen heaters 15b to be turned on, which heat the pressing roller 13, from two to one. The heating control unit 29 maintains the number of the halogen heaters 15a to be turned on, which heats the heating roller 11, at two.

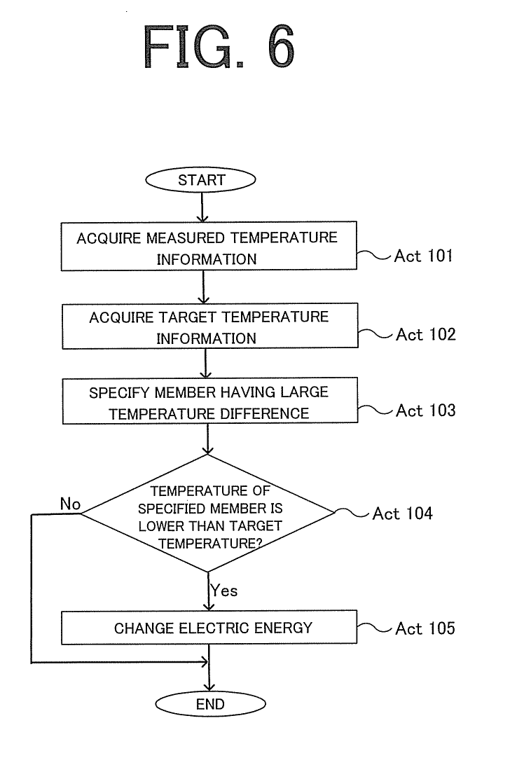

A processing flow concerning a change in electric energy in the fixing device according to the first embodiment is explained with reference to FIG. 6.

First, in Act 101, the measured-temperature-information acquiring unit 23 acquires the temperatures of the heating roller 11 and the pressing roller 13 from the temperature sensors 16 and 17 as measured temperature information and sends the temperatures to the target specifying unit 27.

In Act 102, the target-temperature-information acquiring unit 25 acquires the target temperature table stored in the storing unit 21 as target temperature information and sends the target temperature table to the target specifying unit 27. In Act 103, the target specifying unit 27 specifies the heating roller 11 or the pressing roller 13, a temperature difference between the target temperature and the measured temperature of which is larger. In Act 104, the target specifying unit 27 determines whether the measured temperature of the roller, the temperature difference of which is determined as larger, is lower than the target temperature. If the measured temperature is lower than the target temperature, the target specifying unit 27 specifies the roller, the temperature difference of which is determined as larger and the measured temperature of which is determined as lower than the target temperature, as a roller for which a rate of increase in a heat quantity to be given is set larger.

In Act 105, the heating control unit 29 changes, using the heating control table acquired from the storing unit 21, electric energy given to the halogen heaters 15a and 15b such that a rate of increase in a heat quantity given to the roller specified by the target specifying unit 27 is larger than a rate of increase in a heat quantity given to the other roller. On the other hand, if it is determined in Act 104 that the measured temperature is equal to or higher than the target temperature, the fixing device 7 ends the processing without executing the processing by the heating control unit 29 (end).

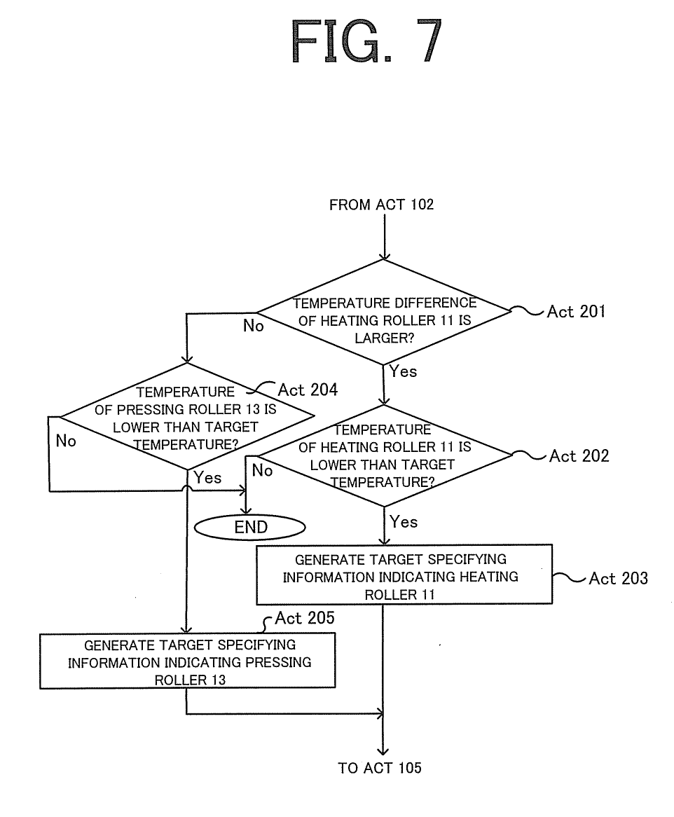

The processing in Acts 103 and 104 is more specifically explained with reference to FIG. 7.

First, the target specifying unit 27 determines whether the temperature difference of the heating roller 11 is larger than the temperature difference of the pressing roller 13 (Act 201). If the temperature difference of the heating roller 11 is larger than the temperature difference of the pressing roller 13, in Act 202, the target specifying unit 27 determines whether the measured temperature of the heating roller 11 is lower than the target temperature. If the measured temperature of the heating roller 11 is lower than the target temperature, the target specifying unit 27 generates target specifying information indicating the heating roller 11 as a target for which a rate of increase in a heat quantity to be given is set larger and sends the target specifying information to the heating control unit 29 (Act 203). On the other hand, if the measured temperature of the heating roller 11 is equal to or higher than the target temperature, the target specifying unit 27 ends the processing.

If the temperature difference of the heating roller 11 is smaller than the temperature difference of the pressing roller 13, in Act 204, the target specifying unit 27 determines whether the measured temperature of the pressing roller 13 is lower than the target temperature. If the measured temperature of the pressing roller 13 is lower than the target temperature, the target specifying unit 27 generates target specifying information indicating the pressing roller 13 as a target for which a rate of increase in a heat quantity to be given is set larger and sends the target specifying information to the heating control unit 29 (Act 203). On the other hand, if the measured temperature of the pressing roller 13 is equal to or higher than the target temperature, the target specifying unit 27 ends the processing.

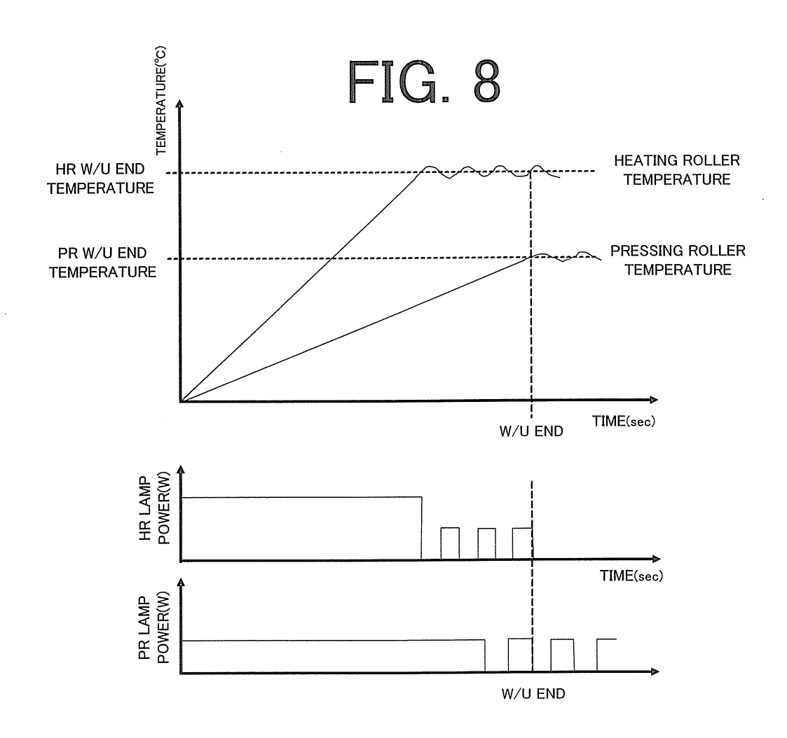

As shown in FIG. 8, in the past, in some case, one of the heating roller 11 and the pressing roller 13 reaches the target temperature earlier. In that case, there is a waiting time from the acquisition of the start request until printing can be prepared.

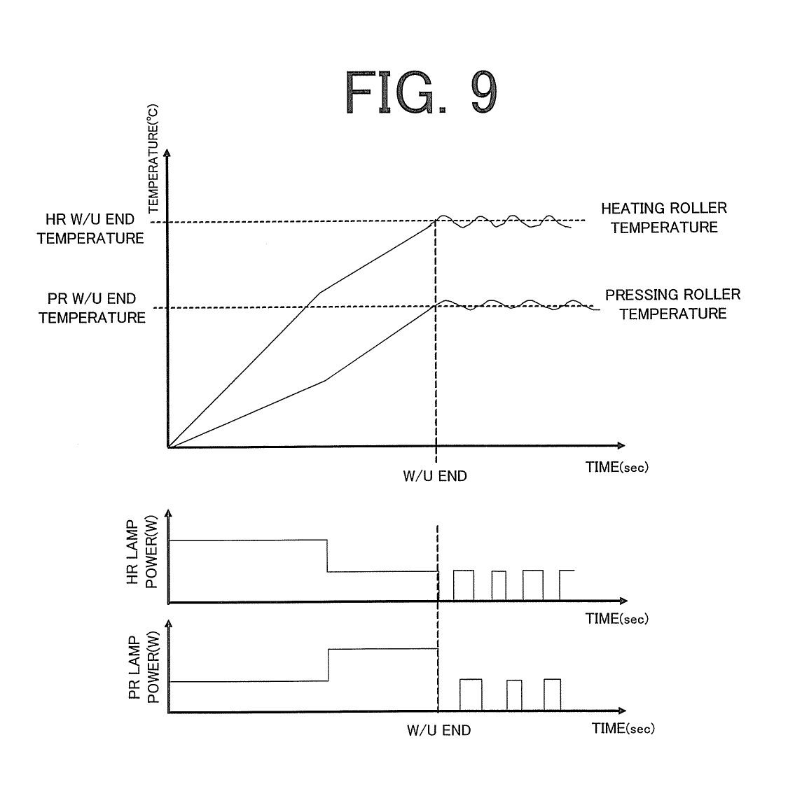

According to the first embodiment, as shown in FIG. 9, a rate of increase in electric energy given to the heat generation source configured to heat the member having a larger temperature difference until the member reaches the target temperature is set larger. Consequently, a rate of increase in a heat quantity given to the member having the larger temperature difference can be set larger and timings when the members reach the target temperatures can be set, for example, substantially simultaneous. As a result, it is possible to reduce the waiting time from the acquisition of the start request until printing can be prepared.

### Second Embodiment

A second embodiment is explained below. Components same as those in the first embodiment are denoted by the same reference numerals and signs and explanation of the components is omitted (the same applies in embodiments explained below).

In the second embodiment, the fixing device 7 rotates the heating roller 11 (pre-run) when a predetermined time elapses after a start request is acquired (e.g. after start processing for the heating roller 11 is completed and the rotation of the heating roller 11 can be executed).

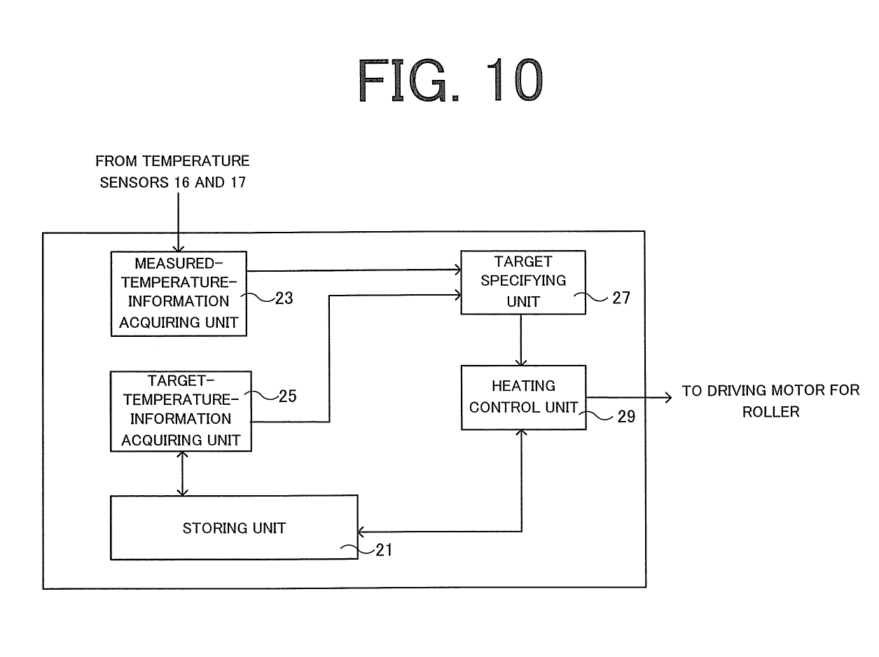

FIG. 10 is a diagram of functional blocks concerning heating control in the second embodiment.

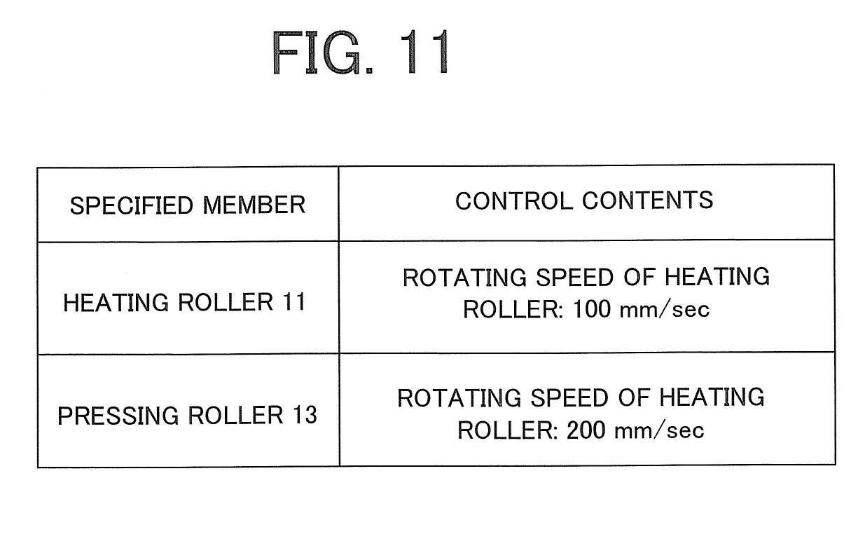

In the second embodiment, the heating control unit 29 controls the rotating speed of the driving motor for the heating roller 11 on the basis of a heating control table shown in FIG. 11 to thereby set a rate of increase in a heat quantity to be given larger for the roller specified by the target specifying unit 27 than for the other roller.

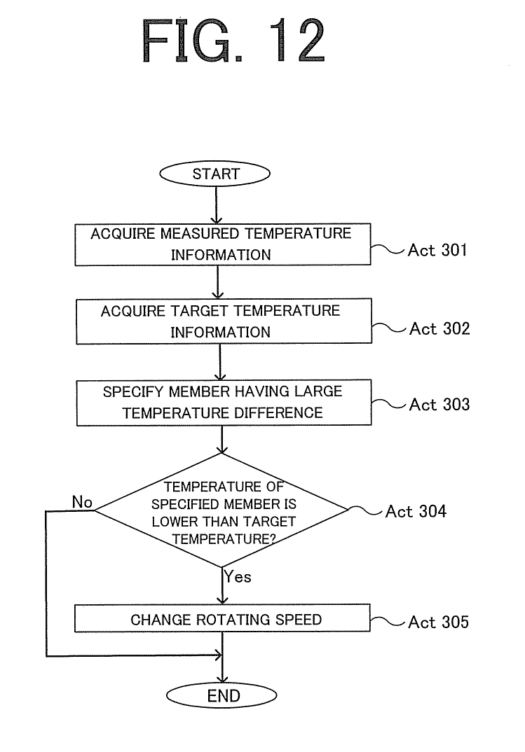

FIG. 12 is a flowchart for explaining a processing flow concerning setting of rotating speed in the fixing device according to the second embodiment. Concerning Acts 301 to 304, since processing contents are the same as those in the first embodiment, explanation of the acts is omitted.

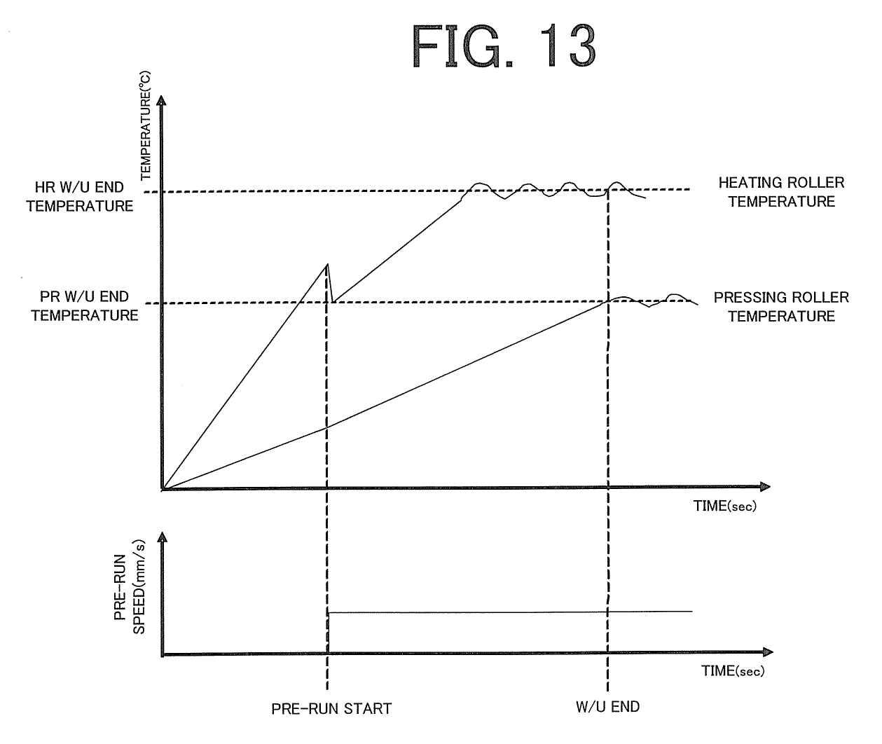

In Act 305, the heating control unit 29 acquires, according to the acquisition of the target specifying information sent from the target specifying unit 27, a heating control table shown in FIG. 13 stored in the storing unit 21. Subsequently, the heating control unit 29 sets the rotating speed of the heating roller 11 in the pre-run on the basis of the target specifying information and the heating control table.

For example, it is assumed that the pressing roller 13 is specified by the target specifying unit 27. In this case, the heating control unit 29 sets the rotating speed of the heating roller 11 to, for example, 200 mm/sec on the basis of the heating control table shown in FIG. 13. Further, it is assumed that the heating roller 11 is specified by the target specifying unit 27. In this case, the heating control unit 29 sets the rotating speed of the heating roller 11 to, for example, 100 mm/sec on the basis of the heating control table shown in FIG. 13.

In other words, if the pressing roller 13 is specified by the target specifying unit 27, the heating control unit 29 controls the driving motor for the heating roller 11 to set the rotating speed of the heating roller 11, which rotates the fixing belt 14, higher than the rotating speed of the heating roller 11 set when the heating roller 11 is specified by the target specifying unit 27. In this way, the rotating speed of the heating roller 11 is set higher than the rotating speed of the heating roller 11 set when the heating roller 11 is specified by the target specifying unit 27. Consequently, a rate of increase in a heat quantity to be given is set larger for the pressing roller 13 than for the heating roller 11.

If the heating roller 11 is specified by the target specifying unit 27, the heating control unit 29 controls the driving motor for the heating roller 11 to set the rotating speed of the heating roller 11, which rotates the fixing belt 14, lower than the rotating speed of the heating roller 11 set when the pressing roller 13 is specified by the target specifying unit 27. In this way, the rotating speed of the heating roller 11 is set lower than the rotating speed of the heating roller 11 set when the pressing roller 13 is specified by the target specifying unit 27. Consequently, a rate of increase in a heat quantity to be given is set larger for the heating roller 11 than for the pressing roller 13.

As shown in FIG. 13, in the past, in some case, one of the heating roller 11 and the pressing roller 13 reaches the target temperature earlier. In that case, there is a waiting time from the acquisition of the start request until printing can be prepared.

In the second embodiment, when the pre-run is executed, the rotating speed of the heating roller 11 is changed to adjust a heat quantity transmitted from the fixing belt 14 to the pressing roller 13 via the nip section such that a larger heat quantity is given to the roller side having a larger temperature difference. Consequently, timings when the rollers reach the target temperatures can be set, for example, substantially simultaneous.

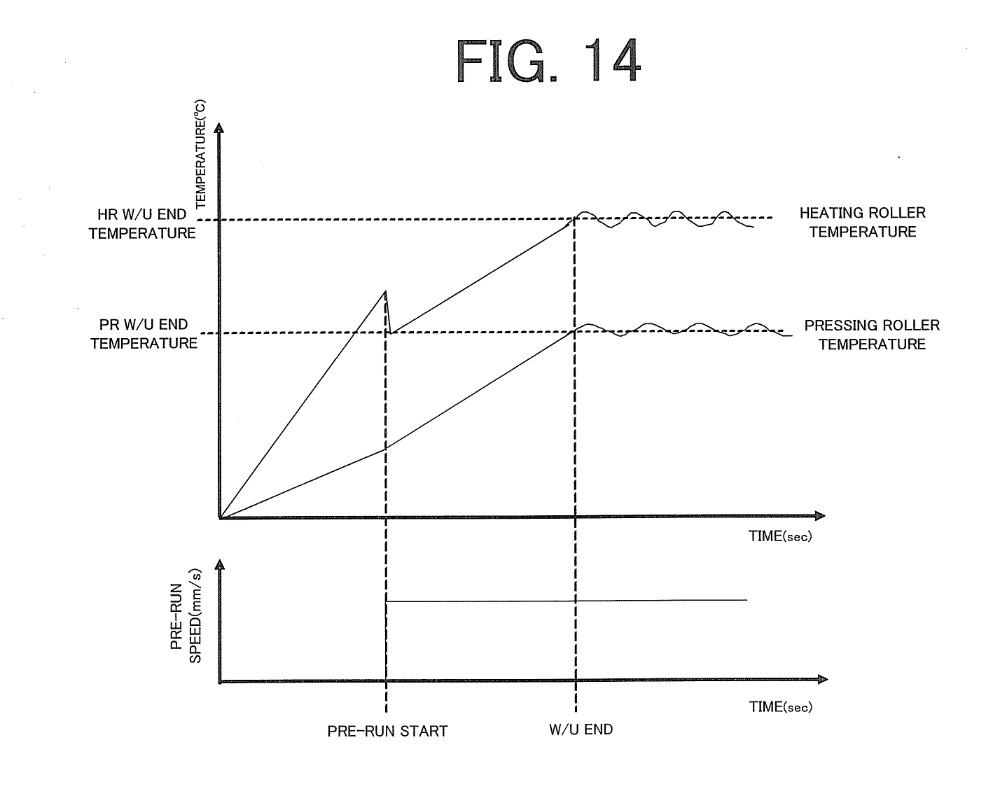

For example, as shown in FIG. 14, if a temperature difference between measured temperature and the target temperature is larger in the pressing roller 13 than the heating roller 11, the rotating speed of the heating roller 11 is increased, whereby the rotating speed of the fixing belt 14 is increased to increase the heat quantity transmitted from the fixing belt 14 to the pressing roller 13.

If the temperature difference between the measured temperature and the target temperature is larger in the heating roller 11 than the pressing roller 13, the rotating speed of the heating roller 11 is reduced, whereby the rotating speed of the fixing belt 14 is reduced to suppress the heat quantity transmitted from the fixing belt 14 to the pressing roller 13.

As a result, it is possible to reduce the waiting time from the acquisition of the start request until printing can be prepared.

### Third Embodiment

A fixing device according to a third embodiment includes, in addition to the components explained in the first embodiment, a driving mechanism configured to change the arrangement position of the pressing roller 13 (hereinafter simply referred to as driving mechanism for the pressing roller 13). The fixing belt 14 and the pressing roller 13 can be separated by the driving mechanism.

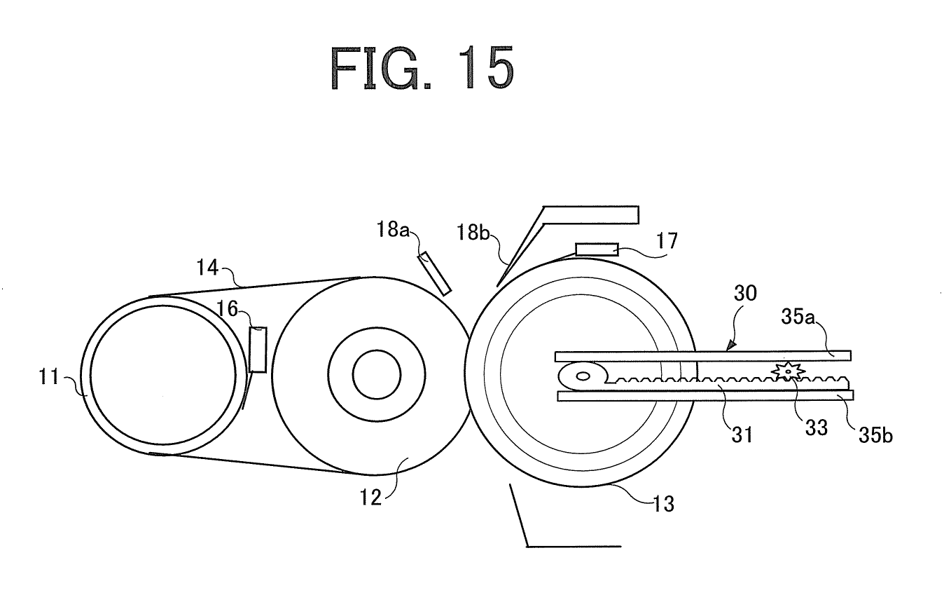

FIG. 15 is a schematic diagram of the configuration of the fixing device according to the third embodiment. Although description is omitted to facilitate understanding, as in the first embodiment, the halogen heaters 15a are arranged on the inside of the heating roller 11 and the halogen heaters 15b are arranged on the inside of the pressing roller 13.

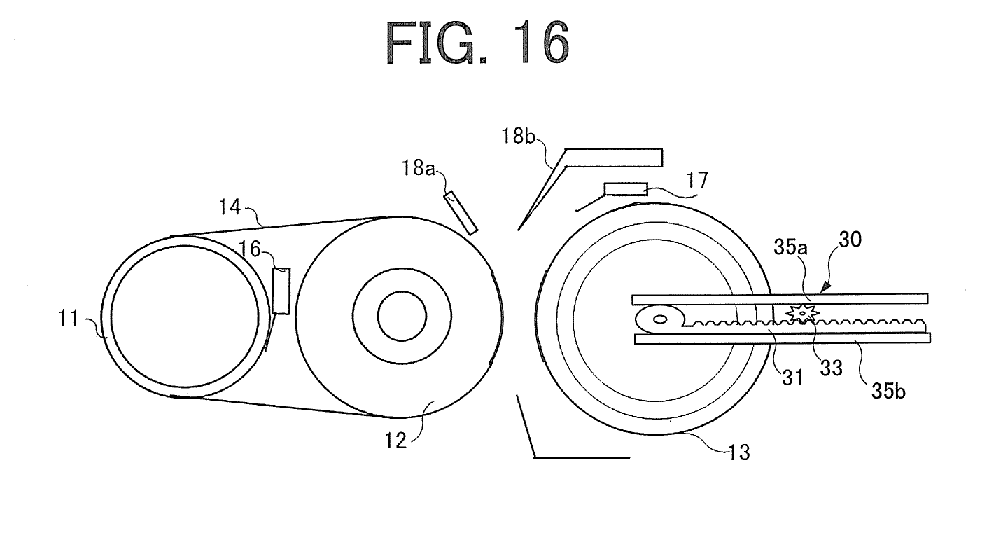

A driving mechanism 30 for the pressing roller 13 can be, for example, a pinion-and-rack mechanism. In FIG. 15, the driving mechanism 30 for the pressing roller 13 includes a rack 31 coupled to the pressing roller 13, a pinion gear 33, linear guides 35a and 35b, and a not-shown driving motor coupled to the pinion gear 33. The driving motor is actuated and the pinion gear 33 rotates, whereby the pressing roller 13 moves and the position of the pressing roller 13 is changed as shown in FIG. 16. As a result, the heating roller 11 and the pressing roller 13 in contact with each other are separated and the contact is released.

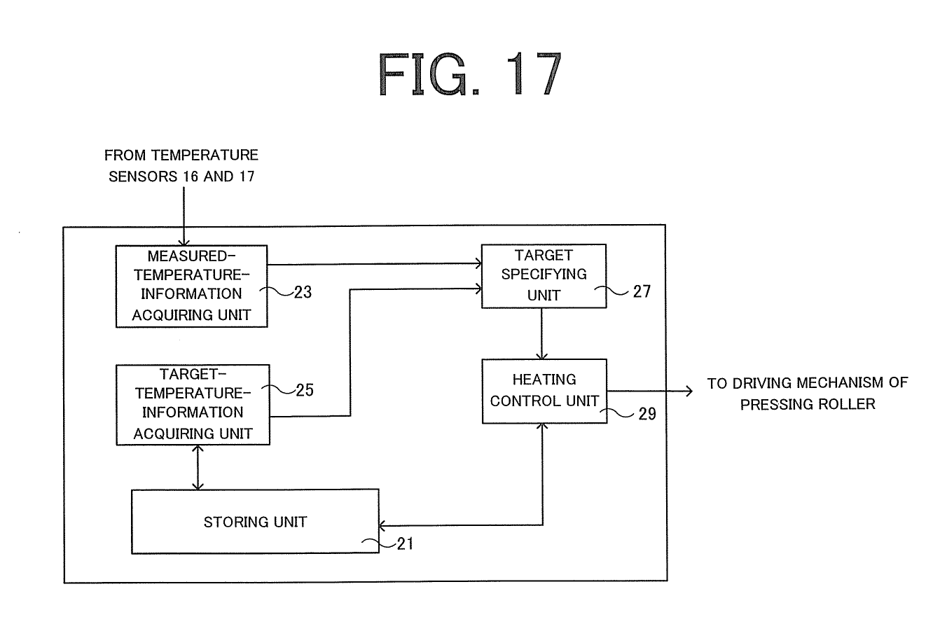

FIG. 17 is a diagram of functional blocks related to heating control in the third embodiment.

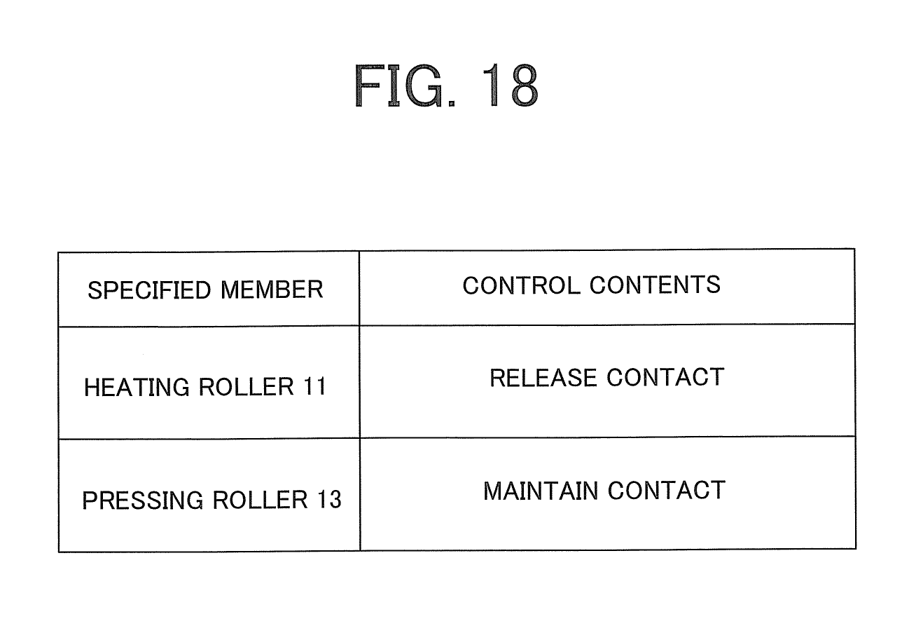

The heating control unit 29 controls, on the basis of a heating control table shown in FIG. 18, the driving mechanism 30 for the pressing roller 13 to maintain or change the position of the pressing roller 13 to thereby maintain or release the contact of the fixing belt 14 and the pressing roller 13. Consequently, the heating control unit 29 sets a rate of increase in a heat quantity to be given larger for the roller specified by the target specifying unit 27 than for the other roller.

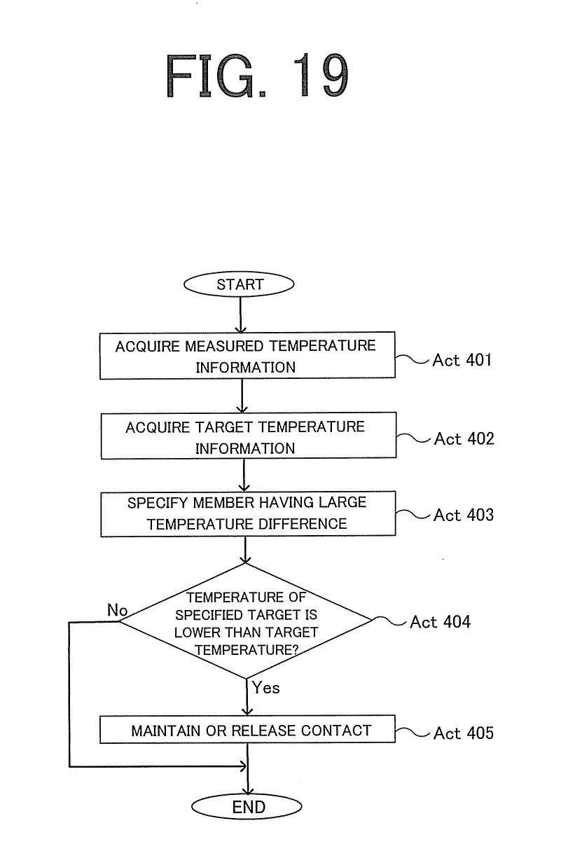

FIG. 19 is a flowchart for explaining a processing flow concerning setting of rotating speed in the fixing device according to the third embodiment. Concerning Acts 401 to 404, since processing contents are the same as those in the first embodiment, explanation of the acts is omitted.

In Act 405, the heating control unit 29 acquires, according to the acquisition of the target specifying information sent from the target specifying unit 27, the heating control table shown in FIG. 18 stored in the storing unit 21. Subsequently, the heating control unit 29 controls the driving mechanism 30 for the pressing roller 13 on the basis of the target specifying information and the heating control table to change the position of the pressing roller 13 to thereby maintain or release the contact of the fixing belt 14 and the pressing roller 13.

For example, it is assumed that the heating roller 11 is specified by the target specifying unit 27. In this case, the heating control unit 29 controls the driving mechanism 30 for the pressing roller 13 on the basis of the target specifying information and the heating control table shown in FIG. 18 to change the position of the pressing roller 13 to thereby separate the fixing belt 14 and the pressing roller 13 and release the contact of the fixing belt 14 and the pressing roller 13. The heating control unit 29 releases the contact of the fixing belt 14 and the pressing roller 13 in this way to set a rate of increase in a heat quantity to be given larger for the heating roller 11 than for the pressing roller 13.

It is assumed that the pressing roller 13 is specified by the target specifying unit 27. In this case, the heating control unit 29 controls the driving mechanism 30 for the pressing roller 13 to maintain the position of the pressing roller 13 to thereby maintain the contact of the fixing belt 14 and the pressing roller 13. The target specifying unit 27 maintains the contact of the fixing belt 14 and the pressing roller 13 in this way to set a rate of increase in a heat quantity to be given larger for the pressing roller 13 than for the heating roller 11.

By releasing the contact of the fixing belt 14 and the pressing roller 13, heat can be prevented from being transmitted from the fixing belt 14 to the pressing roller 13. Therefore, if a temperature difference between measured temperature and the target temperature is larger in the heating roller 11, it is possible to set a heat quantity given to the heating roller 11 larger by separating the fixing belt 14 and the pressing roller 13.

### Fourth Embodiment

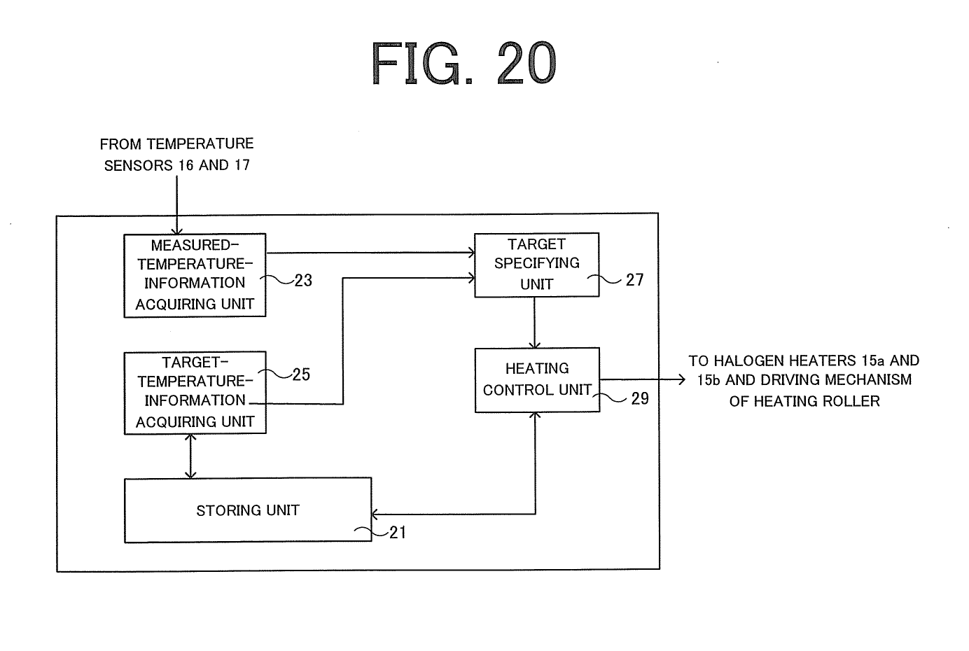

FIG. 20 is a diagram of functional blocks related to heating control according to a fourth embodiment.

A fixing device according to the fourth embodiment includes a temperature-difference-threshold determining unit 22 in addition to the components explained in the third embodiment.

In the fourth embodiment, the measured-temperature-information acquiring unit 23 sends measured temperature information to the temperature-difference-threshold determining unit 22 in addition to the target specifying unit 27.

Similarly, the target-temperature-information acquiring unit 25 sends a target temperature table as target temperature information acquired from the storing unit 21 to the temperature-difference-threshold determining unit 22 in addition to the target specifying unit 27.

The target specifying unit 27 sends the target specifying information to the temperature-difference-threshold determining unit 22.

If the heating roller 11 is specified by the target specifying unit 27 as a target for which a heat quantity to be given is set larger, the temperature-difference-threshold determining unit 22 determines, on the basis of the acquired measured temperature information, target temperature table, and target specifying information, whether a temperature difference between measured temperature and the target temperature of the heating roller 11 is equal to or larger than a predetermined value (e.g., 30° C.). If it is determined that the temperature difference is equal to or larger than the predetermined value, the temperature-difference-threshold determining unit 22 generates temperature difference information indicating that the temperature difference is equal to or larger than the predetermined value and sends the temperature difference information to the heating control unit 29 together with the target specifying information.

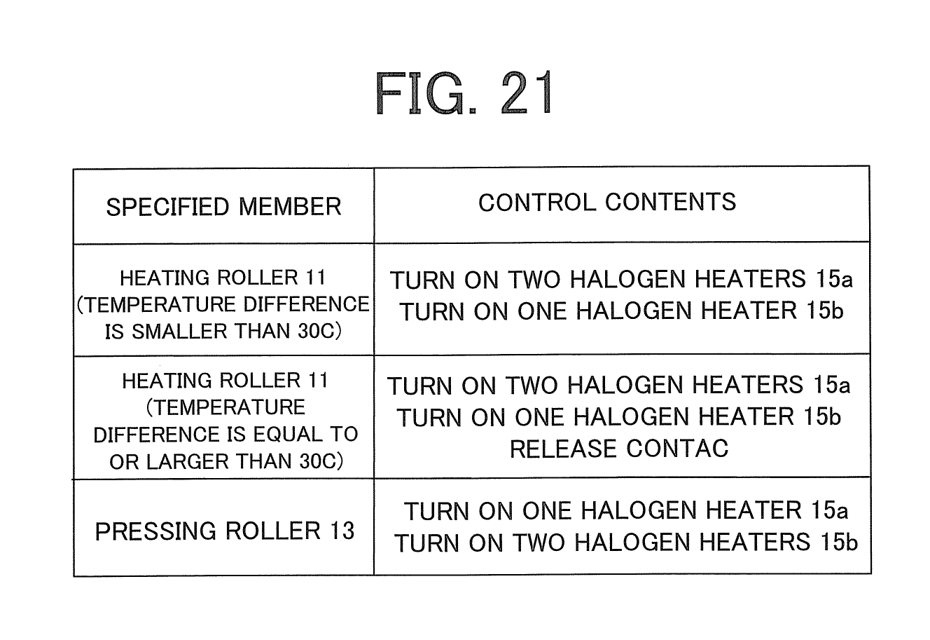

When the heating control unit 29 acquires the temperature difference information in addition to the target specifying information, the heating control unit 29 performs heating control based on the target specifying information, threshold determination information, and a heating control table shown in FIG. 21.

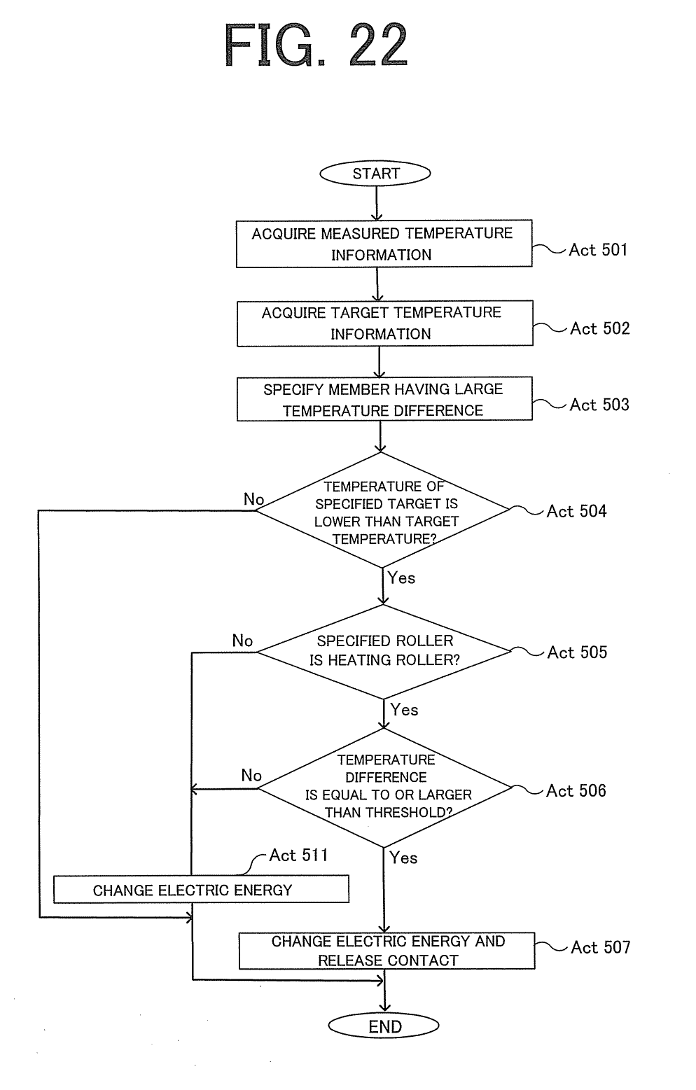

FIG. 22 is a flowchart for explaining a processing flow concerning setting of rotating speed in the fixing device according to the fourth embodiment. Concerning Acts 501 to 503, since processing contents are the same as those in Acts 101 to 103 in the first embodiment, explanation of the acts is omitted.

In Act 504, as in the first embodiment, the target specifying unit 27 determines whether the measured temperature of the heating roller 11 or the pressing roller 13, the temperature difference of which is determined as larger, is lower than the target temperature. If the measured temperature is equal to or higher than the target temperature, the target specifying unit 27 ends the processing. On the other hand, if the measured temperature is lower than the target temperature, the target specifying unit 27 generates target specifying information. In the fourth embodiment, the target specifying unit 27 sends the target specifying information to the temperature-difference-threshold determining unit 22.

In Act 505, the temperature-difference-threshold determining unit 22 determines, on the basis of the target specifying information, whether the roller specified by the target specifying unit 27 is the heating roller 11. If the specified roller is not the heating roller 11 (i.e., if the specified roller is the pressing roller 13), the temperature-difference-threshold determining unit 22 sends the target specifying information to the heating control unit 29 without generating temperature difference information. In Act 511, as in the first embodiment, the heating control unit 29 changes electric energy using the heating control table.

On the other hand, if the heating roller 11 is specified by the target specifying unit 27, the processing proceeds to Act 506. The temperature-difference-threshold determining unit 22 determines, using the target temperature table and the measured temperature information, whether a temperature difference between the measured temperature and the target temperature of the heating roller 11 is equal to or larger than a threshold. If the temperature difference is smaller than the threshold, the temperature-difference-threshold determining unit 22 sends the target specifying information to the heating control unit 29 without generating temperature difference information. In Act 511, as in the first embodiment, the heating control unit 29 changes electric energy using the heating control table.

On the other hand, if the temperature difference is equal to or larger than the threshold, the temperature-difference-threshold determining unit 22 generates temperature difference information and sends the temperature difference information to the heating control unit 29 together with the target specifying information. In Act 507, the heating control unit 29 executes change of electric energy using the target specifying information, the heating control table, and the temperature difference information and controls the driving mechanism 30 for the pressing roller 13 to change the position of the pressing roller 13 to thereby release the contact of the fixing belt 14 and the pressing roller 13.

### Other Embodiments

The first to fourth embodiments are explained above. However, it goes without saying that other modes can also be adopted.

The processing explained above may be applied during return to preheating or during return to sleep besides when the MFP acquires the start request in a power-off state (warming-up).

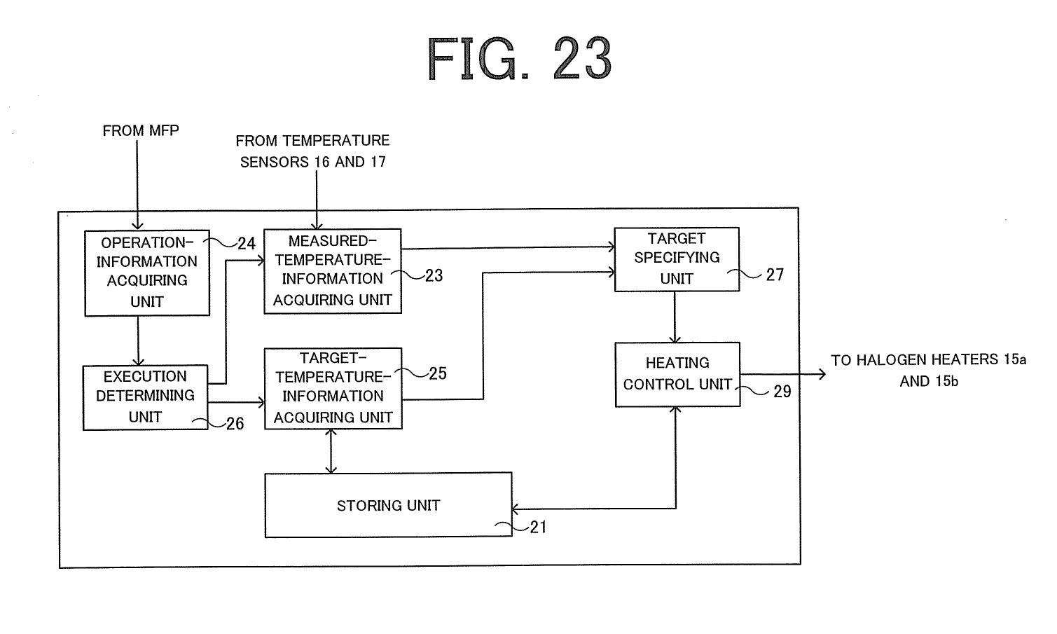

As another embodiment, as shown in FIG. 23, the fixing device 7 may include an operation-information acquiring unit 24 and an execution determining unit 26.

For example, as explained in the first embodiment, the measured-temperature-information acquiring unit 23 and the target-temperature-information acquiring unit 25 can be set to acquire measured temperature information and target temperature information at predetermined timings.

The operation-information acquiring unit 24 acquires, from the inside of the MFP or the outside of the MFP, operation information concerning an operation state at the time when heating of the heating roller 11 and the pressing roller 13 of the fixing device 7 according to the first embodiment is started and sends the operation information to the execution determining unit 26.

The execution determining unit 26 determines, using the acquired operation information, whether the measured-temperature-information acquiring unit 23 and the target-temperature-information acquiring unit 25 can acquire the measured temperature information and the target temperature information before the predetermined timings. For example, if the start processing by the CPU 801 is already completed when the heating of the heating roller 11 and the pressing roller 13 is started, the execution determining unit 26 determines that the measured-temperature-information acquiring unit 23 and the target-temperature-information acquiring unit 25 can respectively acquire the measured temperature information and the target temperature information before the predetermined timings.

If the execution determining unit 26 determines that the measured-temperature-information acquiring unit 23 and the target-temperature-information acquiring unit 25 can respectively acquire the measured temperature information and the target temperature information before the predetermined timings elapse, the execution determining unit 26 causes the measured-temperature-information acquiring unit 23 and the target-temperature-information acquiring unit 25 to respectively execute acquisition of the measured temperature information and the target temperature information before the elapse of the predetermined timings.

In short, the measured-temperature-information acquiring unit and the target-temperature-information acquiring unit respectively acquire the measured temperature information and the target temperature information at the predetermined timings,

the fixing device further includes: an operation-information acquiring unit configured to acquire operation information concerning an operation state of an image forming apparatus mounted with the fixing device; and an execution determining unit configured to determine whether the measured-temperature-information acquiring unit can acquire the measured temperature information and the target-temperature-information acquiring unit can acquire the target temperature information before the elapse of the respective predetermined timings, and

the measured-temperature-information acquiring unit and the target-temperature-information acquiring unit respectively execute, if the execution determining unit determines that the measured temperature information can be acquired and the target temperature information can be acquired before the elapse of the respective predetermined timings, acquisition of the measured temperature information and the target temperature information before the elapse of the predetermined timings.

This makes it possible to perform the processing by the target specifying unit 27 and the heating control unit 29 at earlier timing after the heating of the heating roller 11 and the pressing roller 13 is started. As a result, the waiting time can be further reduced.

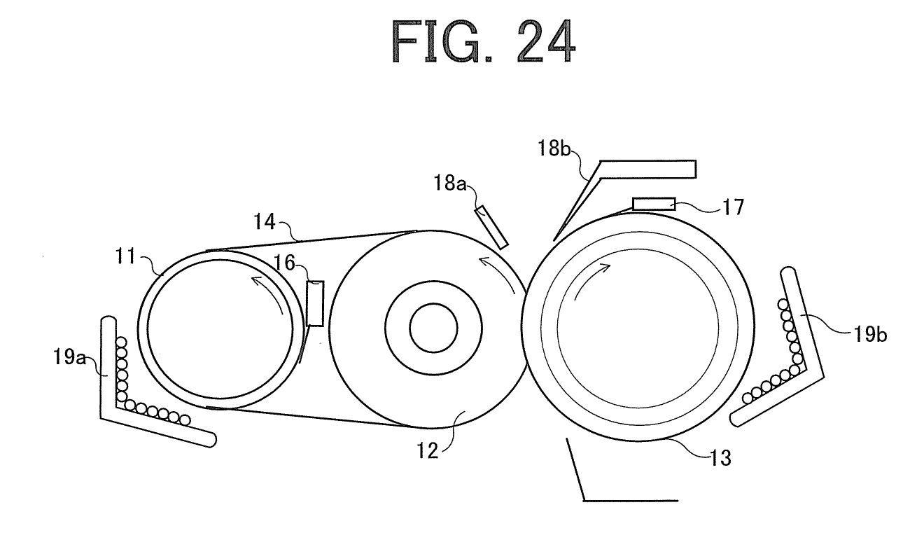

In the first to fourth embodiments, the configuration for heating the heating roller with the halogen heaters is explained as the example. However, the present invention is not limited to this. For example, as shown in FIG. 24, the fixing device may include IH coils 19a and 19b configured to heat the heating roller using the IH (Induction Heating) system. In other words, the fixing device may include, instead of the first heat generation source and the second heat generation source, a first magnetic-field generation source configured to generate a magnetic field for causing the heating member to generate heat using electromagnetic induction and a second magnetic-field generation source configured to generate a magnetic field for causing the pressing member to generate heat using electromagnetic induction. In this case, the heating control unit controls the first magnetic-field generation source and the second magnetic-field generation source to set a rate of increase in a heat quantity to be generated larger for the member specified by the target specifying unit than for the other member. More specifically, the heating control unit sets a rate of increase in electric energy given to the magnetic-field generation source that causes the member specified by the target specifying unit to generate heat larger than a rate of increase in electric energy given to the magnetic-field generation source that causes the other member to generate heat.

In the first to fourth embodiments, the system for rotating the fixing belt 14 using the heating roller 11 is adopted. However, the present invention is not limited to this. For example, a system for rotating the fixing roller 12 or the pressing roller 13 can also be adopted.

In the first embodiment, the configuration including the heating roller 11, the fixing roller 12, and the pressing roller 13 is explained as the example. However, it goes without saying that the present invention can also be applied to a fixing device including, on the inside or the outside of a fixing roller, a heat generation source configured to heat the fixing roller and not including a heating roller besides the fixing roller.

In the second embodiment, the rotating speed of the heating roller 11 is set at a point when the pre-run is started. However, the present invention is not limited to this. For example, it is also possible that, after the pre-run is started at predetermined rotating speed, temperature differences between the target temperatures and the measured temperatures of the heating roller 11 and the pressing roller 13 are compared and the rotating speed of the heating roller 11 is changed on the basis of a result of the comparison.

In the first to fourth embodiments, it is explained that the target temperature information is acquired. However, the present invention is not limited to this. For example, predetermined target temperature is set in advance in a computer program.

The processing for changing a heat quantity may be performed plural times until measured temperature reaches target temperature.

The non-contact temperature sensor 16 may be arranged in a position near the surface of the fixing belt 14 wound around the outer circumferential surface of the heating roller 11.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

As explained above in detail, according to the technique described in this specification, it is possible to reduce a waiting time until image output can be performed.

What is claimed is:

1. A fixing device comprising:
a heating member configured to heat a toner image formed on a recording medium;
a pressing member configured to come into press contact with the heating member and nip and convey a sheet in cooperation with the heating member;
a first heat generation source configured to heat the heating member;
a second heat generation source configured to heat the pressing member;
a measured-temperature-information acquiring unit configured to acquire measured temperature information concerning measured temperatures of the heating member and the pressing member;
a target specifying unit configured to specify, using the measured temperature information acquired by the measured-temperature-information acquiring unit, the heating member or the pressing member as a member for which a rate of increase in a heat quantity to be given is set larger; and
a heating control unit configured to control the first heat generation source and the second heat generation source and set the rate of increase in the heat quantity to be given to the heating member or the pressing member specified by the target specifying unit larger.

2. The device according to claim 1, wherein the target specifying unit specifies, as the member for which the rate of increase in the heat quantity to be given is set larger, the member, the measured temperature of which is equal to or lower than predetermined temperatures respectively set for the heating member and the pressing member and a temperature difference between the measured temperature and the predetermined temperature of which is larger.

3. The device according to claim 1, wherein the heating control unit sets a rate of increase in electric energy to be given to the first heat generation source or the second heat generation source that heats the member specified by the target specifying unit larger.

4. The device according to claim 1, wherein
the fixing device includes a heating roller as the heating member, a stretching and suspending roller configured to rotate around a rotation axis parallel to a rotation axis of the heating roller, and a fixing belt as the heating member wound and suspended around the heating roller and the stretching and suspending roller, and
the heating control unit sets, if the pressing member is specified by the target specifying unit, rotating speed of the rollers that rotate the fixing belt higher than rotating speed set when the heating member is specified by the target specifying unit.

5. The device according to claim 4, wherein the heating control unit sets, if the heating member is specified by the target specifying unit, the rotating speed of the rollers that rotate the fixing belt lower than rotating speed set when the pressing member is specified by the target specifying unit.

6. The device according to claim 1, wherein
the fixing device includes a heating roller as the heating member, a stretching and suspending roller configured to rotate around a rotation axis parallel to a rotation axis of the heating roller, and a fixing belt as the heating member wound and suspended around the heating roller and the stretching and suspending roller, and
the heating control unit separates the pressing member and the fixing belt when the heating member is specified by the target specifying unit.

7. The device according to claim 1, wherein
the fixing device includes a heating roller as the heating member, a stretching and suspending roller configured to rotate around a rotation axis parallel to a rotation axis of the heating roller, a fixing belt as the heating member wound and suspended around the heating roller and the stretching and suspending roller, and a temperature-difference-threshold determining unit configured to determine, when the heating member is specified by the target specifying unit, whether the temperature difference of the heating member is larger than a predetermined value, and
the heating control unit separates the pressing member from the fixing belt when the temperature-difference-threshold determining unit determines that the temperature difference of the heating member is equal to or larger than the predetermined value.

8. A temperature control method for a fixing device including: a heating member configured to heat a toner image formed on a recording medium; a pressing member configured to come into press contact with the heating member and nip and convey a sheet in cooperation with the heating member; a first heat generation source configured to heat the heating member; and a second heat generation source configured to heat the pressing member,
the method comprising:
acquiring measured temperature information concerning measured temperatures of the heating member and the pressing member;
specifying, using the acquired measured temperature information, the heating member or the pressing member as a member for which a rate of increase in a heat quantity to be given is set larger; and
controlling the first heat generation source and the second heat generation source and setting the rate of increase in the heat quantity to be given to the specified heating member or pressing member larger.

9. The method according to claim 8, further comprising setting a rate of increase in electric energy to be given to the first heat generation source or the second heat generation source that heats the specified member larger.

10. The method according to claim 8, wherein
the fixing device includes a heating roller as the heating member, a stretching and suspending roller configured to rotate around a rotation axis parallel to a rotation axis of the heating roller, and a fixing belt as the heating member wound and suspended around the heating roller and the stretching and suspending roller, and
the method further comprises setting, when the pressing member is specified, rotating speed of the rollers that rotate the fixing belt higher than rotating speed set when the heating member is specified.

11. The method according to claim 10, further comprising setting, when the heating member is specified, the rotating speed of the rollers that rotate the fixing belt lower than rotating speed set when the pressing member is specified.

12. The method according to claim 8, wherein
the fixing device includes a heating roller as the heating member, a stretching and suspending roller configured to rotate around a rotation axis parallel to a rotation axis of the heating roller, and a fixing belt as the heating member wound and suspended around the heating roller and the stretching and suspending roller, and
the method further comprises separating the pressing member and the fixing belt when the heating member is specified.

13. The method according to claim 8, wherein
the fixing device includes a heating roller as the heating member, a stretching and suspending roller configured to rotate around a rotation axis parallel to a rotation axis of the heating roller, and a fixing belt as the heating member wound and suspended around the heating roller and the stretching and suspending roller, and
the method further comprises:
determining, when the heating member is specified, whether the temperature difference of the heating member is larger than a predetermined value; and
separating the pressing member from the fixing belt when it is determined that the temperature difference of the heating member is equal to or larger than the predetermined value.

14. A fixing device comprising:
a heating member configured to heat a toner image formed on a recording medium;
a pressing member configured to come into press contact with the heating member and nip and convey a sheet in cooperation with the heating member;
a first magnetic field generation source configured to generate a magnetic field for causing the heating member to generate heat using electromagnetic induction;
a second magnetic field generation source configured to generate a magnetic field for causing the pressing member to generate heat using electromagnetic induction;
a measured-temperature-information acquiring unit configured to acquire measured temperature information concerning measured temperatures of the heating member and the pressing member;
a target specifying unit configured to specify, using the measured temperature information acquired by the measured-temperature-information acquiring unit, the heating member or the pressing member as a member for which a rate of increase in a heat quantity to be given is set larger; and
a heating control unit configured to control the first magnetic field generation source and the second magnetic field generation source and set the rate of increase in the heat quantity to be given to the heating member or the pressing member specified by the target specifying unit larger.

15. The device according to claim 14, wherein the target specifying unit specifies, as the member for which the rate of increase in the heat quantity to be given is set larger, the member, the measured temperature of which is equal to or lower than predetermined temperatures respectively set for the heating member and the pressing member and a temperature difference between the measured temperature and the predetermined temperature of which is larger.

16. The device according to claim 14, wherein the heating control unit sets a rate of increase in electric energy to be given to the first magnetic field generation source or the second magnetic field generation source that causes the member specified by the target specifying unit larger to generate heat.

17. The device according to claim 14, wherein
the fixing device includes a heating roller as the heating member, a stretching and suspending roller configured to rotate around a rotation axis parallel to a rotation axis of the heating roller, and a fixing belt as the heating member wound and suspended around the heating roller and the stretching and suspending roller, and
the heating control unit sets, when the pressing member is specified by the target specifying unit, rotating speed of the rollers that rotate the fixing belt higher than rotating speed set when the heating member is specified by the target specifying unit.

18. The device according to claim 17, wherein the heating control unit sets, when the heating member is specified by the target specifying unit, the rotating speed of the rollers that rotate the fixing belt lower than rotating speed set when the pressing member is specified by the target specifying unit.

19. The device according to claim 14, wherein
the fixing device includes a heating roller as the heating member, a stretching and suspending roller configured to rotate around a rotation axis parallel to a rotation axis of the heating roller, and a fixing belt as the heating member wound and suspended around the heating roller and the stretching and suspending roller, and
the heating control unit separates the pressing member and the fixing belt when the heating member is specified by the target specifying unit.

20. The device according to claim 14, wherein
the fixing device includes a heating roller as the heating member, a stretching and suspending roller configured to rotate around a rotation axis parallel to a rotation axis of the heating roller, a fixing belt as the heating member wound and suspended around the heating roller and the stretching and suspending roller, and a temperature-difference-threshold determining unit configured to determine, when the heating member is specified by the target specifying unit, whether the temperature difference of the heating member is larger than a predetermined value, and
the heating control unit separates the pressing member from the fixing belt when the temperature-difference-threshold determining unit determines that the temperature difference of the heating member is equal to or larger than the predetermined value.
